(19) United States
(12) Patent Application Publication
(10) Pub. No.: US 2020/0067157 A1
(43) Pub. Date: Feb. 27, 2020

(54) HYBRID COOLING FOR BATTERY PACK

(71) Applicant: Electric Power Systems, LLC, Hyde Park, UT (US)

(72) Inventors: Randy Dunn, Orange, CA (US); Alan Horn, Macomb, MO (US); Nathan Millecam, North Logan, UT (US)

(73) Assignee: Electric Power Systems, LLC, Hyde Park, UT (US)

(21) Appl. No.: 16/552,921

(22) Filed: Aug. 27, 2019

Related U.S. Application Data
(60) Provisional application No. 62/723,377, filed on Aug. 27, 2018.

(51) Int. Cl. H01M 10/6556; F28F 13/08; H01M 10/613; H01M 10/6568; H01M 2/20; H01M 10/625

(52) U.S. Cl. CPC H01M 10/6556; F28F 13/08; H01M 10/613; H01M 2220/20; H01M 2/206; H01M 10/625; F28F 2250/102; H01M 10/6568

(57) ABSTRACT

Electrochemical cell battery system and associated methods of operation are provided based on the incorporation of a thermal suppression construct including a supply of cooling fluid dispensed in intimate contact with the cells disposed within an enveloping sealed enclosure. The electrochemical cells are connected electrically by bus bars to form a battery of cells. The bus bars support cooling by convection methods. The cells are allowed to float mechanically as they are charged and discharged while maintaining intimate thermal contact with the enveloping sealed enclosure through conduction and the bus bars through conduction. The system provides a method of cooling the cells by conduction and convection and that accommodates mechanical changes to both the cells and the enveloping sealed enclosure.

### CROSS REFERENCE TO RELATED APPLICATIONS

This application is a non-provisional of, claims priority to, and the benefit of, U.S. Provisional Patent Application Ser. No. 62/723,377 filed on Aug. 27, 2018 entitled “HYBRID COOLING FOR BATTERY PACK,” which is incorporated by reference herein in its entirety.

### TECHNICAL FIELD

The present disclosure relates generally to a battery, and, more particularly to a secondary battery for a vehicle comprised of a plurality of electrochemical or electrostatic cells.

### BACKGROUND

A secondary battery is a device consisting of one or more electrochemical or electrostatic cells, hereafter referred to collectively as “cells”, that can be charged electrically to provide a static potential for power or released electrical charge when needed. The cell is basically comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Other types of cells include capacitors, which can come in the form of electrolytic, tantalum, ceramic, magnetic, and include the family of super and ultra capacitors. Such cells are mass produced, driven by an ever-increasing consumer market that demands low cost rechargeable energy for portable electronics. Energy density is a measure of a cell's total available energy with respect to the cell's mass, usually measured in Watt-hours per kilogram, or Wh/kg. Power density is a measure of the cell's power delivery with respect to the cell's mass, usually measured in Watts per kilogram, or W/kg.

In order to attain the desired operating voltage level, cells are electrically connected in series to form a battery of cells, what is typically referred to as a battery. In order to attain the desired current level, cells are electrically connected in parallel. When cells are assembled into a battery, the cells are often linked together to provide electrical communication between cells through metal strips, straps, wires, bus bars, etc., that are welded, soldered, or otherwise fastened to each cell to link them together in the desired configuration.

Secondary batteries are often used to drive traction motors in order to propel electric vehicles. Such vehicles include electric bikes, motorcycles, cars, busses, trucks, trains, and so forth. Such traction batteries are usually large format types, comprised of tens to hundreds or more individual cells. The cells are linked together internally and installed into a case to form the completed battery.

Construction of such batteries requires a complex combination of cooling, heating, electrical connection, and mechanical stabilization. Cooling and heating of lithium ion cells, hereafter referred to simply as cooling for brevity, is required to ensure they have long operating life. Electrical connection is required to link the cells together in order to deliver power to the operating load. Mechanical stabilization is required to make battery packs that can be installed into systems as an operational unit.

Conduction cooling and heating by way of a circulating fluid is a very convenient and well proven method for cell cooling. However, the designer must ensure that the circulating fluid does not cause shorting to the electrical components of the cells. Convection cooling and heating mitigates such concerns but is less effective and often increases the volume of the battery system, which is undesirable. Component cost of conduction cooling and heating using a circulating fluid is typically much higher than that if a convection cooling and heating solution is used. So the designer is often left to decide which approach can be afforded in their system and weigh the tradeoffs of cost versus performance.

It is the intent of the present disclosure to provide a cooling and heating solution that thermally manages the cells in a battery system, while maintaining low cost that and incorporates features of both conduction and convection.

From the forgoing, it will be apparent to the reader that one important and primary object of the present disclosure resides in the provision of a novel method to thermally manage a battery of electrochemical cells by conduction using a first fluid and by convection using a second. The disclosure has the advantage of being very low cost and thermally managing the cell internally as well as externally and can be produced using cost effective materials and techniques on low cost conventional machinery.

### BRIEF DESCRIPTION OF THE DRAWINGS

The accompanying drawings, which are hereby incorporated into and constitute a part of this specification, illustrate example embodiments and, together with the description, serve to explain the principles set forth in this disclosure. In the drawings, wherein like reference numerals represent like parts:

FIG. 1 is a side view diagram representing a battery in accordance with an example embodiment.

FIG. 2 is a top view diagram showing a serpentine flow style coolant path of the hollow enclosure from FIG. 1 in accordance with an example embodiment.

FIG. 3 is a top view diagram showing the balanced side flow coolant path of the hollow enclosure from FIG. 1 in accordance with an example embodiment.

FIG. 4 is a method to thermally manage a battery, in accordance with an example embodiment.

### DETAILED DESCRIPTION

The proposed battery solution is an apparatus, comprising a sealed hollow enclosure (1) capable of housing one or more cells (2). The hollow enclosure (1) comprises slots having an internal surface and an external surface that are configured to house the one or more cells (2). The cell (2) may extend partially out of the slot above the top surface of the hollow enclosure (1).

The hollow enclosure may be made from a wide variety of electrically non-conductive materials capable of be providing the mechanical support for the cells and having the ability to be completely sealed to prevent leakage or ingress of contaminants. Various plastics, including Acrylonitrile butadiene styrene (ABS) and high-density polyethylene (HDE), and the like are suitable materials. Such materials can be recycled in order to increase their environmental friendliness and reduce cost.

Cells are disposed within slots in the hollow enclosure (1) having an internal surface, which is internal to the hollow enclosure and an external surface, which is external to the hollow enclosure. Substantially the entire cell (2) surface is in intimate contact with the external surface of the slot. The outer cell (2) surface to external surface interface may be facilitated by use of a thin layer of thermally conductive compound to fill in the air gaps. This material may be applied to the surface of the cell (2) before it is inserted into the hollow enclosure (1).

The hollow enclosure (1) design is sealed, with one or more inlet ports (4) and one or more outlet ports (5) for a thermally conductive fluid (6) to pass through. The inlet ports (4) and outlet ports (5) are disposed on the exterior of the hollow enclosure, and their locations can vary based on the interfacing components. A flow path is created through the hollow enclosure (1) and the flow path is configured to connect the inlet port (4) to the outlet port (5) and creates a cooling channel through the enclosure. The design is such that the fluid (6) passing through is forced to come into intimate contact with the internal surface of the slots as it snakes its way through the hollow enclosure and around all of the slots. Thus, the external temperature of the cell (2) is thermally managed through conduction by the thermally conductive fluid (6) as heat is transferred through the slots to the cell (2). Furthermore, through the flow path, turbulence creators can be added to create a more desirable heating coefficient and allowing better thermal management of the cells (2).

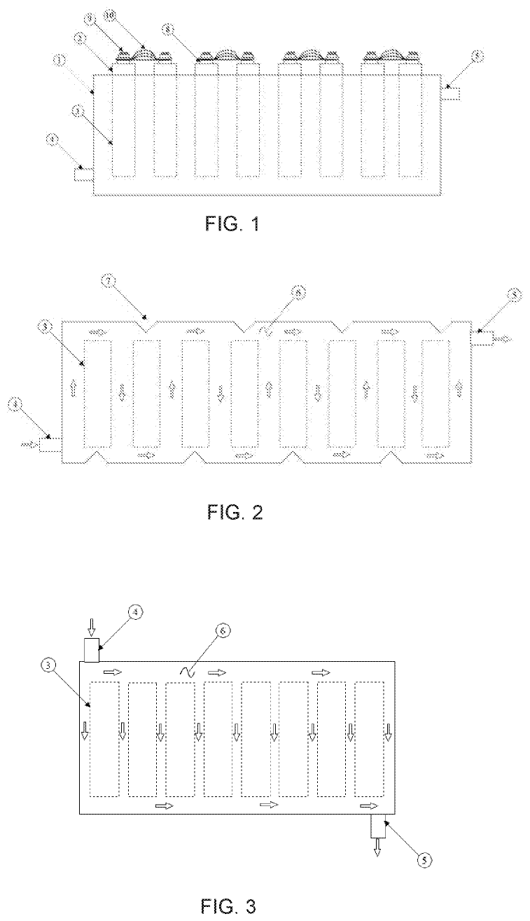

Depending on the application, different flow paths may be utilized in the design. FIG. 2 shows a serpentine shape for the flow path. In accordance with the arrows shown in FIG. 2, the flow is directed at least one corrugated indentation (7) in the sides of the hollow enclosure (1) that forces the fluid to flow around the slots housing each cell (2) disposed therein and also serve to strengthen the hollow enclosure (1) mechanically. Additionally, the fluid may constantly flow under the cells as well, as illustrated in FIG. 1. FIG. 3 shows a balanced flow path. In accordance with the arrows shown in FIG. 3, the flow is inserted into one corner of the hollow enclosure (1) at inlet port (4) and flows across the four sides of each cell (2), as well as the bottom of each cell (2) disposed therein. The entry channel and exit channel, indicated by the rightward pointing arrows, are substantially larger than the at least one inter-cell cooling channel, indicated by the downward pointing arrows. This allows for a more equalized flow rate and pressure across the surfaces of each cell (2). By having the outlet port (5) on the opposing corner of the hollow enclosure (1), the pressure is balanced across all of the cells (2) disposed in the hollow enclosure (1) so that each gets the same amount of coolant and flow rate.

The fluid (6) is pumped, cooled or heated externally using conventional fluid moving equipment, thereby cooling or heating the cells (2) as desired. The depicted fluid (6) path and hollow enclosure (1) indentations (7) are representational, and it is noted that a wide variety of variation is available to the designer to optimize for various characteristics in the design without departing from the spirit of the present disclosure.

The hollow enclosure (1) is preferably made of thin material to enhance the thermal conduction between the fluid (6) and the cells (2). The process of manufacture may use injection molding, blow molding or similar processes. Blow molding, such as is used to make dairy milk one gallon containers, is preferred as it is a very low cost high volume process for consumer goods using very low cost and simple machinery. However, other low cost methods, such as injection molding, can be used without departing from the spirit of the disclosure. The solution of the present disclosure uses a single low cost part, the hollow enclosure (1), in order to contain and cool a plurality of cells (2). Further, the hollow enclosure (1) may be ribbed for improved structural integrity.

Such low cost hollow enclosures (1) will not have very tight physical accuracy over the final product. This is a limitation of such low cost manufacturing processes. Once the cells (2) are inserted into the slots (3) of the hollow enclosure (1), the position of their tops and cell terminals (8) will vary substantially. In addition, the thin walls of the hollow enclosure (1) will move when the flow rate varies, when the temperature fluctuates, and as the cells (2) themselves swell and decay over time and as they cycle. Therefore, a low-cost approach to managing the terminals (8) and bus bar interconnects is needed.

To overcome this, the present disclosure employs use of a stud welding process to attach a threaded stud (9) to the top of each cell rather than welding a bus bar directly to the top of the cell (2). The latter may be problematic with the substantial first cell to second cell variance that happens as a result of the low cost hollow enclosure production method. The stud welding process uses a form of capacitive discharge welding to attach threaded studs to a surface. This process is low cost, fast, and uses parts that are mass produced for the fastener industry. The speed of this process keeps it from overheating and thereby damaging the cells (2). The process provides a broad area of connection between the stud (9) and the terminals (8) of the cell (2), as opposed to the conventional process of spot welding a battery strap directly to the cell terminal that requires repeated welds of small conduction area that may heat up the cell (2) in the process. This process is also faster than the more expensive laser welding processes, and requires much less investment in machinery. It has also been shown to be more repeatable under less controlled conditions, further reducing cost and improving quality.

Connection of the cells is done with a flexible copper bus bar (10) that comprises a plurality of layers of thin copper. Copper is the preferred bus bar material as it has the lowest resistance for the cost of any suitable conductor and therefore results in less energy loss and less heat generation when current flows through it. The bus bars (10) have a non-linear contour to improve flexibility, and are punched with a first hole and a second hole, so the first threaded stud is configured to receive the first hole and the second threaded stud is configured to receive the second hole. The bus bars can be screwed or bolted on to a first threaded stud and a second threaded stud on the cell (2). The flexibility allows the installer to move the bus bar (10) and position it over the stud (9) during installation. It also takes up the mechanical changes in the cells (2) and the hollow enclosure (1) both as they are cycled and as they age. The bus bars (10) are secured to the studs (9) using conventional nuts and washers.

Copper cannot be welded by any conventional techniques directly to cells that have aluminum terminals, so this process allows copper bus bars to be attached directly to lithium ion cells that have aluminum terminals. The copper bus bars (10) have a fanned out lamination structure as shown in FIG. 1 that allows airflow to pass over and under each layer of the lamination. This provides access to a great deal of exposed surface area for thermal transfer. Copper is highly thermally conductive, and since the bus bars (10) are conductive bolted to the cell terminals (8), they can be used to pull heat from or put heat into the internals of the cell (2) directly from the current collectors and the electrodes by forcing hot or cold air through and around them. This results in a greater ability to thermally manage the internal temperature of the cell (2). Thus, the present disclosure supports hybrid cooling and heating of the cells (2), from the inside through the bus bars (10) as well as simultaneously outside through the hollow enclosure (1). Thus, in an example embodiment, the system further comprises a fan, blower, suction fan, pump, or other device for causing movement of the convection fluid.

In a novel manner, the present disclosure enables a tremendous hybrid cooling and heating advantage, including external conduction through moving fluid and internal convection by cooling or heating the cell (2) internals through the terminal by airflow over a high surface area copper bus bar (10). Although airflow is mentioned, other fluids could be utilized to heat or cool the cell (2) through convection. It also provides for a very low cost mechanical hollow enclosure (1) produced on low cost machinery for the cells (2) to reside that is flexible and accommodating as the fluid (6) moves through said hollow enclosure (1) and the cells (2) are cycled through use of highly flexible bus bars (10). Further, the terminals (8) on the cells are attached to by way of a low cost stud (9) and associated welding fabrication techniques that allows copper connection directly to the cell terminals (8). Another benefit set forth by the present disclosure over the prior art concerns shipping costs. As lithium ion batteries are considered hazardous materials, they are expensive to ship. Product weight is a significant cost driver in shipping costs. The hollow enclosure (1) set forth in the present disclosure may be shipped empty, the thermally conductive fluid (6) may be shipped separately non-hazmat which saves on cost, or separately acquired at the destination. Since the hollow enclosure (1) is made from thin wall light-weight plastic, it is extremely light-weight when not filled with thermally conductive fluid (6) and therefore not a significant contributor to the overall battery weight.

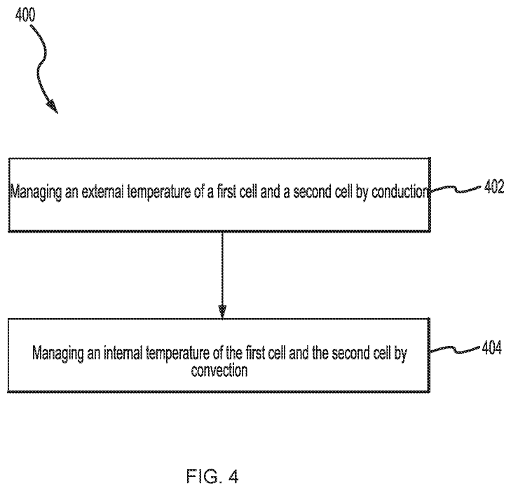

Referring now to FIG. 4, a method (400) for thermally managing a battery, in accordance with an example embodiment, is illustrated. The method comprises managing an external temperature of a first cell and a second cell by conduction (step 402). Managing the external temperature may occur by flowing a thermally conductive fluid around an external surface of the first cell and an external surface of the second cell. The fluid may flow through channels of a hollow enclosure. The channels may maximize the surface area that the fluid contacts when flowing through the channels. The method (400) may further comprise managing an internal temperature of the first cell and the second cell by convection (step 404). Managing the internal temperature may occur by flowing an airflow around a bus coupling the first cell to the second cell. The bus may be disposed external to the hollow enclosure.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. An apparatus comprising:
a hollow enclosure having a slot and a top surface, the slot comprising an internal surface and an external surface;
a first cell disposed in the slot and extending out of the slot above the top surface and having a cell surface that is in intimate contact with the external surface of the slot;
an inlet port disposed on the hollow enclosure;
an outlet port disposed on the hollow enclosure; and
a flow path through the hollow enclosure configured to connect the inlet port and the outlet port.

2. The apparatus of claim 1, further comprising a thermally conductive fluid that passes through the flow path.

3. The apparatus of claim 1, wherein the flow path comprises a corrugated indentation in the side of the hollow enclosure configured to provide a serpentine shape to the flow path.

4. The apparatus of claim 1, wherein the flow path further comprises a cooling channel.

5. The apparatus of claim 4, further comprising a second cell, wherein the cooling channel comprises an entry channel, an exit channel and an inter-cell cooling channel disposed between the first cell and the second cell.

6. The apparatus of claim 5, wherein the entry channel and the exit channel are substantially larger than the inter-cell cooling channel.

7. The apparatus of claim 1, wherein a first threaded stud on the first cell is disposed on a first top surface of the first cell.

8. The apparatus of claim 7, further comprising a second cell having a second threaded stud connected to a second top surface of the second cell, wherein the second cell is electrically connected by a bus bar having a first hole and a second hole, wherein the first threaded stud is configured to receive the first hole and the second threaded stud is configured to receive the second hole.

9. The apparatus of claim 8, wherein the bus bar comprises a non-linear contour to improve flexibility of the bus bar.

10. The apparatus of claim 1, wherein the intimate contact is facilitated by a thermally conductive compound.

11. The apparatus of claim 1, wherein the intimate contact is facilitated by press fitting the first cell into the slot.

12. A system comprising:
an apparatus comprising:
a hollow enclosure having a first slot, a second slot, and a top surface, the first slot and the second slot each comprising an internal surface and an external surface;
a first cell disposed in the first slot;
a second cell disposed in the second slot;
a bus, said bus configured to connect the first cell to the second cell outside the hollow enclosure;
an inlet port disposed on the hollow enclosure;
an outlet port disposed on the hollow enclosure; and
a flow path through the hollow enclosure configured to connect the inlet port and the outlet port;
a first fluid configured to flow through the flow path and thermally manage the first cell and the second cell, through the respective external surface of the first slot and the second slot, by conduction;
a second fluid configured to flow around the bus and thermally manage an internal temperature of the cell by convection.

13. The system of claim 12, wherein the flow path comprises a corrugated indentation in the side of the hollow enclosure configured to provide a serpentine shape to the flow path.

14. The system of claim 12, wherein the apparatus further comprises a second cell, and wherein the flow path further comprises a cooling channel having an entry channel, an exit channel and an inter-cell cooling channel disposed between the first cell and the second cell.

15. A method to thermally manage a battery comprising:
managing an external temperature of a first cell and a second cell in electrical communication through a bus, by conduction, using a fluid that flows around a first outer surface of the first cell and a second outer surface of the second cell; and
managing an internal temperature of the first cell and the second cell, by convection, using airflow over and under the bus that is used to connect the first cell and the second cell.
